(19) United States
(12) Patent Application Publication
(10) Pub. No.: US 2009/0287452 A1
(43) Pub. Date: Nov. 19, 2009

(54) Method and Apparatus for Accurate Footwear and Garment Fitting

(75) Inventors: Maurice Stanley, Worcestershire (GB); Tej Kaushal, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/119,593

(22) Filed: May 13, 2008

(51) Int. Cl. G01B 1/00; G06Q 30/00

(52) U.S. Cl. 702/155; 705/26

(57) ABSTRACT

The invention relates to an improved method of providing customers with indications of whether certain articles, for instance footwear or clothing, will fit that customer and to making recommendations for articles that will fit. The method takes body size data regarding the size/shape of the appropriate body part of the customer and compares the data against a reference body size/shape associated with an article. The reference body size is obtained from the recorded body sizes of previous customers who are known to fit the particular article. A match between the current customer's body size and the reference body size for an article is an indication that such article will fit that customer. The present invention thus avoids any need to obtain any size information about the article itself and can generate the reference body size data through normal retail practices. The invention is particularly applicable to the fitting of shoes.

### BACKGROUND OF THE INVENTION

(1) Summary of the Invention

This invention relates to a method of providing accurate fit recommendations for individuals for footwear and/or garments.

(2) Description of the Art

The correct fitting of footwear continues to be of interest in footwear and clothing retail, especially with the growth of internet based or on-line shopping.

Traditionally a standard size convention has been adopted by manufacturers and, in the field of footwear, most people choose a shoe based on their notional shoe size. For children, whose feet may have grown since a previous shoe fitting, a measurement of foot length and possibly width may be made and compared to a sizing chart to determine the notional shoe size required.

Electronic foot scanners have also been employed to measure a customer's feet and therefore determine the notional shoe size needed by that customer. For instance U.S. Pat. No. 5,164,793 describes a device which scans a laser beams across a foot to be measured and determines three dimensional shape information about the foot. This data is used to determine a length and width for the foot which can then be used to identify a notional shoe size.

However a notional shoe size does not guarantee a good fit. The style of the shoe can affect the fit, for instance the width of the toe section, with the result a customer may require a different notional size for different styles. Further there may be differences in size of shoes of the same general style between different manufacturers.

Correct fitting of shoes can not therefore be assumed with a high degree of confidence based solely on a notional shoes size. This is overcome by retail customers through trying on the notional sized shoe and determining the correct size through trial and error. This is particularly an issue for mail order or internet based shopping where a customer may order shoes based on their notional shoe size only to find that the ordered size in the particular style/manufacturer does not fit. A high rate of returns results in increased cost to the retailer and/or inconvenience to the customer.

To try to account for variations in shoe sizes between styles and manufacturers U.S. Pat. No. 6,741,728 describes a footwear sizing database system which uses precision 3D data of customers feet and also uses precision 3D data of the footlasts used in manufacture of the relevant shoes. It is suggested that for each model of shoe produced by a manufacturer the various footlasts used in manufacturing that shoe could be scanned by a 3D scanning system and the data taken as a representation of the internal volume of the shoe. Customers feet could likewise be scanned and, based on certain key dimensions, a fit chosen based on the foot dimension being within a certain range of appropriate footlast dimension.

This method however requires footlasts to be scanned for each size and model of shoe produced by each manufacturer. This imposes a burden on the manufacturers that not all manufacturers may be willing or able to meet. The footlasts themselves are proprietary to the manufacturer and often a manufacturer may not wish to disseminate dimensions of the lasts used.

Further the size/shape of a footlast is not necessarily a good indicator of what is a comfortable fit for a shoe. The footlast is designed to ensure the shoe material adopts the desired shape during manufacture and the internal shape of the finished shoe may be different to the shape of the footlast. Further the last may be designed to deform the shoe material in a manner that would be uncomfortable for a wearer.

U.S. Pat. No. 6,879,945 describes an alternative footwear sizing method for operation over a computer network such as the internet. A computer is arranged to recommend to a customer a particular size for a chosen model of shoe based on foot size data of the customer and footwear size data for the chosen model. The customer foot size data may be acquired by the customer, for instance the customer may measure their foot against a size chart or use a simple measuring device. Alternatively the customer's foot size data may have been obtained previously in a retail environment. The footwear size data is based on measured internal shoe measurement dimensions in combination with human test group assessments. The customer's past profile may also be used in recommending a particular shoe size.

This method however requires the internal measurements of each size of each model of shoe to be obtained and also requires human assessment. For a retailer selling a large range of models of shoe from various manufacturers this would involve significant effort and cost to develop and maintain.

US Patent Application US2007/0011173 describes a method for providing shoe recommendations based on a user profile. In terms of recommending a fit of shoe it is suggested that a customer may create a shoe profile comprising a list of shoes that they possess and information about the comfort of the fit of those shoes. Shoe recommendations may then be made by identifying other users who also posses the same size and model of shoe and who have indicated the same comfort of fit as the customer. Shoes owned by such other users may be presented to the current customer as recommendations.

Whilst this method does not require any measurement of shoes it relies on common ownership of shoes in making fit recommendations and thus may be not able to make a fit recommendation for every model of shoe a customer may consider. It also requires considerable effort from users to input past shoe history before the system becomes effective.

The same considerations also apply to the fitting of clothing and other items that come in a variety of sizes.

### SUMMARY OF THE INVENTION

It is therefore an object of this invention to provide a method of providing a user with a recommendation or indication regarding the fit of an item of interest to that user which mitigates at least some of the above mentioned disadvantages.

Thus, according to the present invention, there is provided a method of providing a user with an indication of fit for at least one article of interest comprising the steps of: taking user body size data relating to the user; taking reference body size data associated with the at least one article; comparing the user body size data with the reference body size data and indicating whether said article would fit the user; wherein the reference body size information is derived from body size data of a plurality of people known to fit the particular article.

The user body size data will comprise data relating to the appropriate part of the user's body. If the at least one article of interest is a pair of shoes the appropriate user body size data will comprise foot size data. If the article of interest is a pair of gloves the user body size data would comprise hand size data. The articles of interest may be footwear or clothing or indeed anything where it is important to fit the size of the user to the size of the article. The method may provide an indication of fit to a plurality of articles of interest in which case the method may involve indicating which, if any, articles would fit the user. The articles of interest could be differently sized versions of the item, for example the articles of interest may comprise a single model of shoe available in different sizes and the method of the present invention may recommend which, if any, size of said shoe would fit the user. Additionally or alternatively the articles of interest could comprise items of different design, e.g. different styles of shoe, and the method of the present invention could indicate which models would fit the user and/or which model would offer the best fit.

The present invention works by comparing user body size data to known reference body size data to recommend a fit where available. However, unlike methods of the prior art the reference body size data is not concerned with the size of the article per se and is not derived from measurements of the articles in question nor from measurement of items used in their manufacture (such as footlasts for shoes). Nor is the reference body size data merely taken as a notional size from the manufacturer. Instead, in the method of the present invention, the reference body size data is derived from body size data, e.g. previous body size measurements, of other people known to fit the particular article.

The manner in which the reference body size data is derived from the body size data of people known to fit the particular article will be set out in more detail below. However it will be clear that the present invention in effect compares the current user's body size data against size data gathered from other people who are satisfied with the fit of that article to determine the best match. In effect a match to a known body size is identified and the article known to fit said known body size can then be recommended with confidence of fitting correctly. In performing the method of present invention one therefore need not know anything about the actual or relative sizes of articles and no measurement of articles is required.

As mentioned above the user body size data and the reference body size data is data relating to the size of the appropriate part of the body for the article in question. For instance, when the articles of interest are articles of footwear, the user and reference body size data will be data related to foot size. The body size data may well include information about foot shape. The term body size data therefore refers to any data which can be used to give information of the size and/or shape of the appropriate part of the body. The amount and format of body size data available may vary according to the fitting being performed. For instance in fitting of footwear the body size data may comprise a variety of different measurements, for example one or more of heel to toe length, heel width, foot width measured through the ball of the foot, toe length, arch height etc.

In a preferred embodiment the user body size data is obtained from an automatic scanning apparatus such as a two dimensional (2D) or three dimensional (3D) scanner. Various scanners suitable for measuring body size are known in the art, for instance the laser scanning based device of U.S. Pat. No. 5,164,793 described above. Such scanners can be arranged to scan the relevant part of the body, in a range of orientations if necessary, to determine body size data.

A convenient scanning apparatus is the 3D scanning apparatus described in international patent publication WO2004/044525. In such an apparatus a structured light generator projects a two dimensional pattern of light to the scene, such as an array of spots of light. A detector is arranged relative to the structured light generator to monitor the scene and a processor determines, from the position of each spot in the scene the range to that spot. When a body part, such as a foot, is illuminated by such a device the range to a two dimensional array of spots on the foot is determined, from which the 3D shape and size of the foot can be determined.

Conveniently the user body size data is obtained in the same format as the body size data used to derive the reference body size data and conveniently all body size data is obtained in the same general format, which is the same general measurements are made. However, especially for automatic scanning it is not essential that the number of measurement points is the same provided the key dimensions can be determined. Thus different scanning apparatuses can be used for measurement in the method of the present invention.

The present invention uses reference body size data derived from body size data of people known to fit the particular article. There are various methods by which this body size data can be obtained and the reference body size data derived. The method therefore may comprise the step of obtaining body size data from a plurality of people along with details of at least one article known to fit each of said people.

The data could be obtained through controlled trials of each article using people who represent a cross section of the usual body sizes for the appropriate articles, i.e. each article would be tested on a test group of people whose body size data has been acquired. However such a deliberate testing regime would involve a reasonable amount of effort and may not be cost effective or practicable in many applications.

The body size data of people known to fit an article may therefore conveniently be acquired by recording the body size data of customers along with details of articles they indicate they fit. In other words given that customers try various articles in the retail environment and ultimately select items that fit, the information regarding items that do fit can be combined with body size data of that customer to provide the reference body size data.

The customer could therefore uses conventional fitting steps such as, for instance, trial and error based on a notional size to identify articles of interest. Conveniently however user body size data is acquired to assist in the fitting process and an initial fit may be determined by the method of the present invention. This encourages the capture of body size information.

When a customer tries an article and indicates that said article fits that customer, details of said article can be recorded along with the user body size data. For example, consider a shoe store. A customer wishing to buy some shoes may have their feet scanned by a store assistant. The resulting user body size data can be used to recommend a particular size for each model of shoe the customer is interested in. Where there is insufficient reference body size data available (for the article in question) the fit recommendation may instead be made based on calculation of a notional shoe size. The notional shoe size can then be used as the basis for trial of a range of shoes the customer is interested in. If the assistant determines that any of the shoes tried by the customer are a good fit they can record the appropriate shoe model and size and this can be linked with the stored user body size data. Alternatively the customer deciding to purchase shoes they have tried is a good indication that those shoes do fit that customer and hence record of the shoe size and model purchased by that customer can be stored. Thus in the normal course of shoe retail, user body size data and information about the shoes that body size fits is collected which can be used to derive reference body size data for the appropriate article.

Once sufficient body size data has been collected from people known to fit a particular article and reference body size data has been derived then the method of the present invention can be applied to any new customers. Returning to the example of a shoe store such a new customer would have their feet scanned, if no previous scan data existed, and then the new user body size data would be compared to the reference body size data derived from the body size data of previous customers to identify shoes known to fit that customer's foot size. If this fit is correct and the customer buys the recommended size of shoes this data would be added to the store of body size data of people known to fit those shoes. If however the initial suggested fit was not correct the customer may still select the correct fit through trial of a different size and ultimately buy the correct fit. This data would also be recorded as body size data associated with the shoes they did buy and the reference body size data for those shoes would be updated accordingly. Thus continual operation of the method of the present invention results in increased accuracy off the fit recommendation.

It may also be useful in some instances to record information about articles that the user does not fit, i.e. record a negative indication of fit. This could help refine the accuracy of the fitting method further. However clearly care must be taken to ensure that a non-fit is recorded accurately. Failure to buy a pair of shoes say that a customer has tried does not necessarily indicate a bad fit, the customer may simply not have liked the look of the shoes when worn. Capturing non-fit information would therefore need a definite indication of non-fit from the customer or a fitting assistant.

The idea of recording articles purchased or rented by a customer as an indicator that said article fits said customer can also be extended to remote transactions, for instance internet based shopping or mail order. Thus where a customer orders, for example, a pair of shoes, and does not return said shoes, the shoes can be taken to fit that customer. Clearly the recording of articles known to fit a user is only useful in the method of the present invention if it can be linked to body size data of the user. Body size data of a remote user could be obtained by the user themselves and transmitted with the order for articles or the user may have body size data available which had been acquired previously.

It is obviously important to note that the customer who buys the shoes may not be the person for who the shoes are intended, for instance a parent may be buying shoes for their children. Therefore in associating body size data with an article the actual user of the article is preferably identified and if it is not clear that an article purchased by a user is to be worn by that user then the data may not be recorded. It should be noted however that the method of the present invention is robust and can deal with the occasional incorrect allocation. For example consider the situation of a parent purchasing shoes for more than one child in a shoe store. It is possible that through error the body size data for one of the children is associated with the wrong shoes, i.e. shoes not meant for them. If this body size data is then recorded as being body size data of a person known to fit those shoes the data will be wrong and this may effect the derived reference body size data. However in a data set with tens or hundreds of correctly matched body sizes to the appropriate article the occasional error will have a very minor effect. Further, if there is a significant difference between the body size incorrectly allocated to that articles and the body sizes correctly allocated the fact it is an anomalous point may be easily detected and hence that data could be excluded from the data set and not used in derivation of the reference body size data.

Where user body size data is captured for a particular user is it useful to record this data for future use to avoid the need for repeated measurement/scanning. The useful life of the user body size data may depend on the particular part of the body being measured and the age of the person. The user body size data for children will need to be replaced in line with the growth of the child. For adults, data relating to foot size say may remain current for many years. However user body size data may vary over time due to weight gain or loss. Thus there may be a need to periodically update stored body size data relating to an individual.

The stored user body size data may be provided to the user for their future use or may be stored in a database along with a means of identifying the customer. As mentioned above where a customer has pre-existing user body size data they can use such data in the method of the present invention and can do so in an in-store environment or for remote shopping such as internet based shopping. A user could use a computer to browse available articles to identify any articles of interest. If a user wants to buy an article they could either supply their user body size data or the computer system could use details of the customer to access the correct body size data on a database. The user body size data could then be compared with article size data associated with the article to determine the likely fit.

The reference body size data may be derived from the body size data of people known to fit the article in various ways. For instance the reference body size data could comprise a set of critical dimension ranges or limits or groupings derived from the body size data set of people known to fit the article. In other words the set of body size data collected from people known to fit a particular article could be analysed to determine, for certain defined dimensions, the maximum and minimum within the set of body size data. This could be used to set ranges for the reference body size data.

Alternatively the reference body size data for a particular article could comprise a set of body size data collected from people known to fit the article. In this case the invention may effectively compare the user body size data with body size data of other people to determine a match in body size. Once such a match has been determined the particular article known to fit the particular body data size can be identified.

The reference body size data may be derived from the body size data of other people known to fit the article using self learning techniques. In other words the method may involve collecting body size data from a plurality of people for each article and allowing self learning type algorithms to determine the mapping between body size and article fit.

For best accuracy a reasonable amount of body size data, i.e. the number of people known to fit a particular article, is required to derive the reference body size data. The reference body size data is therefore preferably derived from the body size data of at least one person, ten people, or from at least twenty people, or from at least fifty people, or from at least one hundred people, at least five hundred people or at least one thousand people. The greater the amount of data the more analysis will be needed but the more accurate the resulting article size data may be. Obtaining body size data of a large number of people, say of the order of one hundred or more, for each article would be very time consuming as part of a testing regime. However if the data is acquired through normal retail practices as described above the data may not take long to be acquired—especially for a retailer with a number of different shops all using the method and accessing a common database or were different retailers selling the same articles to share information in a common database. As mentioned above the continually addition of reference body size information to the store also means the accuracy of the fitting continually improves. Where there are gaps in the reference body size database, interpolation techniques may be employed to produce an estimate for the reference size. This may occur, for example, when there is a known brand and style of article and whilst reference body size information has not been accumulated sufficiently for a given size within that range, reference data is available for multiple sizes above and/or below this specific size.

The present invention therefore offers a method of providing fit recommendations to users of articles. The invention compares the body size of the user to reference body size data which is derived from body size data from other users known to fit the particular article. The body size data of other users can be collected as part of the usual business activities of the article providers and hence no particular testing regime is needed. The method requires no information about the size of the article to be obtained but will automatically result in fitting recommendations which are adjusted for the particular style of article.

This method provides added benefit in that the type of fit appropriate to that article is incorporated within the reference body size database. The fit recommendation for new customers of that article will therefore be automatically adjusted for function of that article. An example of this may be that the fit recommendation of children's shoes will automatically incorporate ‘growing room’ as that will have been a factor in the original fit judgement. Similarly, purchasers of running shoes or other specialised sports clothing will automatically have a fit recommendation that is appropriate for their activity or function. This effectively accumulates and utilises the specialist experience of all previous fit recommendations for each article.

The system can provide an indication of fit for articles that are selected through this system by utilising statistical analysis techniques to compare the user's measurements against the reference body size data. This may comprise an overall fit guide such as snug or roomy for each article, or indicate the fit characteristics for specific measurements. The system can also receive input from the purchaser about their preferred fit and take this into account when analysing against reference body size data.

One key aspect of the present invention is the use of body size data of previous users to derive reference size information for the articles, i.e. to derive size data not from the article itself but from the body size of people whom that article is known to fit. Thus in another aspect of the invention there is provided a method of providing reference size information about an article comprising the step of taking body size data of a plurality of people known to fit that article and deriving said reference size information from said body size information.

The method of this aspect of the invention may comprise taking body size data of users and recording articles purchased or hired by or for the user as articles known to fit said user. The method may also involve the step of scanning the user with an 2D or 3D imaging system to acquire body size data of the user.

The methods of the present invention may be implemented on a computer system and another aspect of the present invention is a computer system programmed to carry out at least one of the methods described above. The invention also provides a computer programme on a carrier, which, when loaded into an appropriate computer will perform at least one of the methods described above.

### DESCRIPTION OF THE FIGURE

The invention will now be described by way of example only with respect to the following drawing, of which:

FIG. 1 illustrates the steps of one method of making a fit recommendation according to the present invention as applied to in-store and on-line shoe retail.

### DETAILED DESCRIPTION OF THE INVENTION

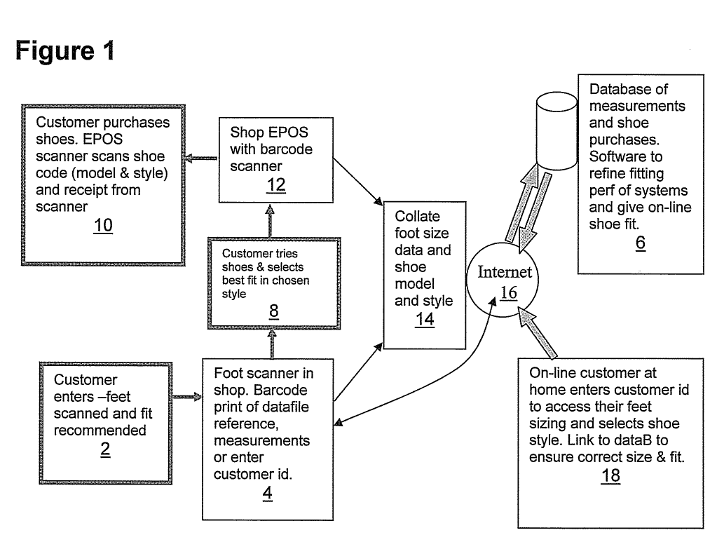

FIG. 1 illustrates the method of the present invention as applied to a shoe store setting offering both in store and on-line shopping. The skilled person will appreciate however that the present invention is applicable to all types of footwear or clothing sales and rental and indeed to any articles which need correct fitting to users. Also there will be other retail solutions which utilise the method of the present invention.

An in store customer wishing to purchase some shoes would browse for shoes they like and decide which shoes they would like to try. Having identified shoes they would like to try a foot data file for that customer would be obtained. If there were no pre-existing foot data file for that customer this would involve having their feet scanned 2 by a three dimensional foot scanner 4.

The foot scanner 4 comprises at least one optical scanning device such as described in WO2004/044525. For each scanning device a spot projector projects an array of spots of light onto the customer's foot. A camera is arranged relative to the spot projector such that the position of the spots in the scene captured by the camera can be used to determine the range to that spot. The entire foot is illuminated and imaged, either by scanning the device relative to the foot or by taking multiple scans of the foot in different orientations. Both feet are scanned and a three dimensional point map of the surface of each foot is constructed. The skilled person will appreciate however that a variety of other scanning technologies could be employed, for instance the foot scanner described in U.S. Pat. No. 5,164,793 and the invention is not limited to any particular form of foot scan.

The foot scanner 4 may process the point map data to determine key dimensions of the foot, such as heel to toe length, width at widest part, heel width etc. and produce a customer foot data file or may simply maintain the 3D shape as the customer foot data file.

The foot data file is stored in the foot scanner 4 for now along with a means of identifying the customer to which the data relates. This could be by allocation of a customer number, time of scan and/or addition of metadata supplied by the customer such the customer's name.

For any particular model of shoe the customer is interested in the foot data file is then compared to a shoe database 6 comprising information of reference foot size data of other people known to have bought the same model of shoe. A matching algorithm is applied to match the current customer's foot size data with the reference foot size data in the shoe database 6. If a match is identified the relevant shoe size associated with the reference foot size data is obtained.

If no match is identified because the database does not contain sufficient data about the chosen model of shoe the fitting is instead performed by simply converting the shoe data file into length and width measurements and determining a notional shoe size from the manufacturer's shoe sizing table.

The identified shoe size is then recommended to the customer.

It should be noted that in some circumstances the shoe of interest to the customer is not available in a size that would fit and, if this is the case, this fact is communicated to the customer.

Also, the fit determined by the matching algorithm or look up table may need to be adjusted for factors specific to the user such as preferred sock thickness or preferred type of fit (snug or roomy). This could be applied by a scaling factor applied to the customer foot data file prior to matching or by applying a compensation algorithm after an initial match has been determined. A constant offset could also be applied.

The fit recommendation is communicated to the customer, for instance by means of a printed recommendation slip. This slip may be provided with a barcode or other identifier which links to the customers foot data file.

The customer would then try on 8 the size of shoe recommended. If the fit is correct and the customer is happy with the shoe and wishes to purchase the item they go on to purchase the shoes 10 as normal. Whilst completing the transaction the barcode identifying the shoes is scanned by the shops electronic point of sale equipment (EPOS) 12 as is the barcode printed on the size recommendation provided to the customer. This therefore identifies the make and model of shoe bought with the customer's foot data file.

The fact that the customer is buying the shoes indicates that the shoes fit that customer and hence the shoe model and size information is collated 14 with the customer's foot data file and communicated to the shoe data base 6.

The shoe database 6 may be in store but preferably a central database is used by a variety of shoe stores and accessed, for instance, via the internet 16. In this way purchase from each of the stores automatically adds to the information in the shoe database which in turn improves the accuracy of the system.

The customer's foot data file may also be stored separately for ease of access for the customer in future use, especially via the internet. Additionally or alternatively it may be written to a removable storage medium to be taken by the customer or sent wirelessly to a date storage device of the customer such as a suitable mobile phone or personal data assistant. The customer may then get to keep their own foot data file. The customer's foot data may also be incorporated into the customer reference number and barcode, so that the printed sizing receipt becomes the stored data file. The retail EPOS system, when scanning the receipt, inputs and stores the customer's size information. The customer, when undertaking a remote transaction for further shoes, enters the customer reference number from the receipt and in doing so provides the fitting system with their relevant measurements. In this situation there is no need to connect each foot scanner to a network or have other means to store and download data files. The sizing information may be encrypted within the customer reference number for commercial and data security reasons.

A customer who had previously had a foot scan could then use such data file in assuring fit in on-line shopping 18. The customer would enter their unique customer number or the metadata taken in the shop to locate their foot data file. Alternatively they could download it onto an appropriate computer. The customer could then browse on-line for shoes that they are interested in. Once they have chosen the shoes they are interested in the foot data file could be compared to the shoe database 6 exactly as described previously and obtain a size recommendation. If the customer is happy to proceed the order could be placed on this basis. If subsequent the customer did not return the shoes within the allowed time for returns this could be taken as an indication they were happy with the fit and this data could be added to the shoe database.

As an alternative or in addition the system could recommend shoes to the customer that they have not selected but which are known would fit the customer's feet. When recommending shoes the system may use shoes that the customer is interested in as a guide. That is if a customer is browsing for a particular style of shoes the system may recommend other shoes of a similar style. The system may also use information regarding the customer such as gender, age, shoe style preference etc. which may for instance be supplied by and customer and/or stored in a customer profile, to make sure the recommendations are appropriate.

The present invention therefore offers several advantages, over conventional shoe fitting techniques. The scanner fitting performance is continuously refined and improved based on what people find comfortable when they purchase shoes in shops. Where expert fitters in the shop help customers to select the correct shoe size, this information will also be automatically accumulated and integrated into the fit recommendation. The system will automatically incorporate and optimise fit recommendation for any brand and style of shoe without needing access to shoe lasts, measuring shoes, or doing controlled fitting trials for each brand or style of shoe. The scanner and database will quickly and automatically learn the fitting performance of new shoe styles which are introduced into the marketplace.

The scanners and database will also automatically learn what are the correct ‘comfort’ factors for different types of shoes e.g. children's, running etc.

Foot size and shoe sale data can be automatically analysed and provided back to the retailer to optimise business efficiency, trend analysis, stock control etc.

Software can analyse the effect of the person having two differently sized feet and the resultant preferred shoe size, and optimise fitting algorithms for these situations.

Following the launch of a new range of shoes in shops and on-line, there will be a short period when the scanner system initially applies an estimated or default sizing information to determine best fit. Once data on the fit performance of this new shoe range starts to be received by the system database, a judgement on the fit accuracy can be determined and new ‘comfort’ compensation factors applied and distributed back to the foot scanners. This process will be iterated until the fit prediction consistently matches the size of shoe purchased. The fit prediction can then become available for on-line shoe sales. This optimisation process may take around 100 shoe sales for a particular style and so is likely to stabilise very quickly, particularly if there are a number of shoe shops connected to the system.

The foot shape can be established using 3D feet shape data or a set of published or undisclosed measurement parameters. Each of the parameters can have a unique ‘comfort’ factor applied for each style or brand of shoe. It is likely these parameters will adopt standard foot metrics used by feet specialists, and so make this foot information valuable to shoe designers and biometric surveys.

Comfort compensation factors can be developed and refined for different customer types through a customer survey/data input e.g. gender, intended use of footwear, ethnic origin etc. Each of these parameters could alter the type of fit compensation applied to the shoe and therefore further improve quality of fit. Customers who don't wish to participate would receive a more generic fit recommendation.

Fit performance could be ultimately tailored to individuals e.g. customer X prefers tighter fitting shoes than the average. This could be established by monitoring the size mapping of that customer compared to the average. Analysis of individual fit parameters could indicate e.g. that the customer has a narrow foot or prefers more volume around the toe. The fit mapping would be automatically tuned for specialist sports footwear e.g. running, golf, hiking etc.

Input of sock type when the foot was scanned could be used to build up accurate compensation for different sock types.

1. A method of providing a user with an indication of fit for at least one article of interest comprising the steps of:
taking user body size data relating to the user;
taking reference body size data associated with the at least one article;
comparing the user body size data with the reference body size data and indicating whether said article would fit the user;
wherein the reference body size data is derived from body size data of a plurality of people known to fit the particular article.

2. A method according to claim 1 comprising taking reference body size data associated with each of a plurality of articles of interest and indicating which, if any, of said plurality of articles of interest would fit the user.

3. A method according to claim 2 wherein the articles of interest comprise differently sized versions of the same item

4. A method according to claim 2 wherein the articles of interest comprise items of different design.

5. A method as claimed in claim 1 wherein the user body size data is obtained from an automatic scanning apparatus.

6. A method as claimed in claim 5 comprising the step of scanning the appropriate part of the body of the user with said automatic scanning apparatus.

7. A method as claimed in claim 6 further comprising the step of recording the user body size data.

8. A method as claimed in claim 1 where user body size data is obtained in the same format as the body size data of the plurality of people known to fit the particular article.

9. A method as claimed in claim 1 comprising the step of obtaining body size data from a plurality of people along with details of at least one article known to fit each of said people.

10. A method as claimed in claim 9 wherein the said body size data from a plurality of people is acquired by recording the body size data of users along with details of articles they indicate they fit.

11. A method as claimed in claim 9 wherein the purchase or hire of an article by a user is used as an indication that said user fits said article.

12. A method as claimed in claim 1 wherein the reference body size data comprises a set of critical dimension ranges or limits derived from the said body size data of a plurality of people known to fit the particular article.

13 A method as claimed in claim 1 wherein the reference body size data comprises a set of clusterings or groupings of measurements derived from said body size data of a plurality of people known to fit the particular article.

14. A method as claimed in claim 1 wherein the reference body size data for a particular article comprises a set of body size data collected from people known to fit said article.

15. A method as claimed in claim 1 wherein the reference body size data is derived from said body size data of a plurality of people known to fit the particular article using self learning techniques.

16. A method as claimed in claim 1 wherein the reference body size data is derived from the body size data of at least one person, or at least ten people, or from at least twenty people, or from at least fifty people, or from at least one hundred people, or from at least five hundred people or from at least one thousand people.

17. A method of providing reference size information about an article comprising the step of taking body size data of a plurality of people known to fit that article and deriving said reference size information from said body size information.

18. A method as claimed in claim 16 wherein the step of taking body size data comprises taking body size data of at least one user and recording articles purchased or hired by or for said user as articles known to fit said user.

19. A method as claimed in claim 16 further comprising the step of scanning a user with an 2D or 3D imaging system to acquire body size data of said user.

20. A method as claimed in claim 17 further comprising the step of scanning a user with an 2D or 3D imaging system to acquire body size data of said user.
